(19) United States
(12) Patent Application Publication
(10) Pub. No.: US 2004/0204191 A1
(43) Pub. Date: Oct. 14, 2004

(54) Portable auditory testing system and method for enhancing the capability of a portable auditory testing device

(76) Inventor: Gabriel Raviv, Glenview, IL (US)

Correspondence Address: MARSHALL, GERSTEIN & BORUN, Anthony G. Sitko, Sears Tower, 233 S. Wacker Drive, Suite 6300, Chicago, IL, 60606-6357, US

(21) Appl. No.: 10/184,314

(22) Filed: Jun. 27, 2002

(51) Int. Cl. H04B 1/38

(52) U.S. Cl. 455/575.1; 455/557; 455/550.1; 455/556.1

(57) ABSTRACT

A portable auditory testing system (170) and a method (400) for enhancing capability of a portable auditory testing device (120) are described herein. The portable auditory testing device (120) and a mobile handheld device (130) may be physically coupled together. The portable auditory testing device (120) may be communicatively coupled to the mobile handheld device (130) via a communication link so that the portable auditory testing device (120) and the mobile handheld device (130) may operate as a single unit. The mobile handheld device (130) may provide the portable auditory testing device (120) with a graphical user interface (820), and a database (830) operable to store information associated with at least one subject.

### TECHNICAL FIELD

The present disclosure relates to auditory assessment, and more particularly, to a portable auditory testing system and a method for enhancing the capability of a portable auditory testing device.

### BACKGROUND

Typically, a portable auditory testing device may be used to perform different objective diagnosis and screening of hearing. For example, the portable auditory testing device may be used for Octoacoustic Emissions (OAE) testing, i.e., recording and analyzing echoes generated in a sealed ear canal in response to acoustic stimulation. The portable auditory testing device may also be used for Auditory Brainstem Response (ABR) testing, i.e., recording and analyzing brain electrical activity recorded from the scalp in response to acoustic stimulation. Thus, the portable auditory testing device provides all of the functionality of a stationary screening device as well as a full diagnostic system into a single device.

The portable auditory testing device generally includes a built-in text display and simple user-input buttons (e.g., scroll buttons) to perform basic functions for a hearing test. For example, the built-in text display may provide helpful messages to guide a user to ensure that the probe fits properly into the ear of a patient. However, the portable auditory testing device may not offer more advanced features such as a database for storage of information associated with a large number of patients, a color display for graphics, and a touch-sensitive screen and/or an alphanumeric keypad for user input. In particular, a user of the portable auditory testing device may not be able to view the test results and/or reports (e.g., distortion product (DP) gram) on the built-in display. The user may be required to scroll line-by-line to view the hearing test data. Further, the portable auditory testing device may not able to provide a graphical representation (e.g., a graph and a chart) of the test results with the built-in text display. Also, the portable auditory testing device may not have sufficient memory to store test results of a large number of patients.

To perform more enhanced and sophisticated features related to hearing test, the portable auditory testing device may be connected to a desktop or laptop computer. For example, a laptop computer may provide a full-sized monitor and an alphanumeric keypad to perform some of the features mentioned above. Further, the laptop computer may provide a memory including a database to store a large amount of information such as test result of each patient tested by the portable auditory testing device. However, neither a desktop nor laptop computer may be mobile enough so that the portable auditory testing device may move and operate at different locations, and also have the enhanced features provided by the desktop or laptop computer be available. Even the smaller and lighter laptop computers available today may not be convenient enough for the user to carry around to perform hearing test because of their inherent size and weight. For example, a laptop computer may not be easily strapped onto a belt of a user and transported from bedside to bedside of different patients.

Therefore, a need exists for retrofitting an existing portable auditory testing device with a mobile handheld device to enhance the capability of the portable auditory testing device.

### BRIEF DESCRIPTION OF THE DRAWINGS

This disclosure will be described in terms of several embodiments to illustrate its broad teachings. Reference is also made to the attached drawings.

FIG. 1 is a block diagram representation of an auditory testing environment.

FIG. 2 is a front perspective representation of a carrying member adapted to retain a portable auditory testing device.

FIG. 3 is a rear perspective representation of the carrying member.

FIG. 4 is a front perspective representation of the carrying member engaging another carrying member adapted to retain a mobile handheld device.

FIG. 5 is a rear perspective representation of the carrying member engaging a belt.

FIGS. 6 and 7 are diagrams illustrating a user engaging the carrying member.

FIG. 8 is a block diagram representation of a mobile handheld device.

FIG. 9 is a flow diagram illustrating a method for enhancing capability of a portable auditory testing device.

### DETAILED DESCRIPTION

A portable auditory testing system and a method for enhancing the capability of a portable auditory testing device are described herein. In an auditory testing environment, a portable auditory testing device is operable to test the hearing of a subject. The portable auditory testing device may be in communication with the mobile handheld device via a communication link (e.g., a wired link and a wireless link) so that the portable auditory testing device and the mobile handheld device may operate as a single portable auditory testing system. That is, the portable auditory testing device may be communicatively coupled to the mobile handheld device via the communication link. For example, the portable auditory testing device may be connected to the mobile handheld device via a cable. In particular, the mobile handheld device may provide the portable auditory testing device with a graphical user interface to view information associated with at least one subject such as hearing test data, and a database to store the information associated with at least one subject. Therefore, the capability of the portable auditory testing device may be enhanced by the mobile handheld device.

In addition to being communicatively coupled to the mobile handheld device, the portable auditory testing device may be physically coupled to a mobile handheld device such as a personal digital assistant (PDA) via a fastener for convenience. For example, the fastener may be a plurality of Velcro®-like material strips with at least one strip disposed on each of the portable auditory testing device and the mobile handheld device. The plurality of Velcro-like material strips may be disposed directly onto the portable auditory testing device and the mobile handheld device. Alternatively, the portable auditory testing device and the mobile handheld device may be disposed in separate carrying members such as, but not limited to, carry cases, holsters, carry sleeves, and carry pouches. At least one Velcro-like material strip may be disposed on the carrying member adapted to retain the portable auditory testing device, and a corresponding Velcro-like material strip may be disposed on the carrying member adapted to retain the mobile handheld device. Thus, the two Velcro-like material strips may be pressed together so that the carrying members retaining the portable auditory testing device and the mobile handheld device may be fastened together. Persons of ordinary skill in the art will readily appreciate that the portable auditory testing device and the mobile handheld device may be physically coupled together in many other ways such as a snap-on mechanism, a slide-in mechanism, and other mechanically joining mechanisms.

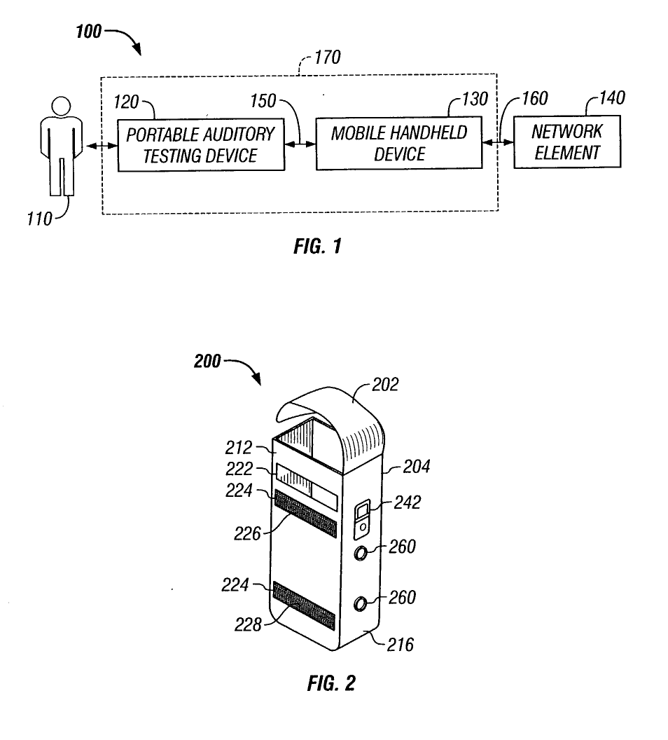

Referring to FIG. 1, an auditory testing environment 100 generally includes a subject 110, a portable auditory testing device 120 (hereinafter “testing device”), and a mobile handheld device 130 (hereinafter “handheld device”). As used herein “handheld device” refers to any computing device (e.g., a personal digital assistant (PDA)) of suitable size and shape that is designed to be carried within a hand of a person. Although the embodiments disclosed herein are particularly well suited for use with mobile handheld devices such as personal digital assistants (PDAs), persons of ordinary skill in the art will readily appreciate that the teachings herein are in no way limited to those devices. On the contrary, persons of ordinary skill in the art will readily appreciate that the teachings can be employed with other mobile handheld devices such as a cellular telephone operable as a handheld computing device.

As explained in detail below, the handheld device 130 is in communication with the testing device 120 via a first communication link 150 so that the testing device 120 and the handheld device 130 may operate as a single unit, i.e., a portable auditory testing system 170. In particular, the testing device 120 and the mobile handheld device 130 are communicatively coupled so that the handheld device 130 may control the operation of the testing device 120 and/or communicate with the testing device 120 via the first communication link 150, which may be either a wired link or a wireless link. For example, the first communication link 150 may be a wired link in which the testing device 120 and the handheld device 130 are connected by a cable. Alternatively, the first communication link 150 may be a wireless link such as, but not limited to, a radio link and an infrared link between the testing device 120 and the handheld device 130. To communicate via a radio link, for example, the testing device 120 and the handheld device 130 may operate in accordance with a wireless communication protocol such as, but not limited to, a Bluetooth based communication protocol and an Institute of Electrical and Electronics Engineers (IEEE) 802.11 based communication protocol (e.g., IEEE 802.11b). In accordance with an Infrared Data Association (IrDA) based communication protocol, the testing device 120 and the handheld device 130 may communicate via an infrared link.

Further, the handheld device 130 may be in communication with a network element 140 via a second communication link 160. The network element 140 may be, but is not limited to, a printer, a monitor, a laptop computer, a desktop computer, a management information system, and another mobile handheld device. Similar to the first communication link 150, the second communication link 160 may be a wired link or a wireless link as described above so that the handheld device 130 may perform a variety of hearing test functions. For example, the network element 140 may be a printer to generate a self-adhesive label with information associated with a subject (e.g., hearing test results) from the handheld device 130 for immediate placement in a medical file. The network element 140 may also be a management information system (MIS) including a database for storing information associated with patients. Thus, the handheld device 130 may be loaded with information associated with a patient from the MIS prior to testing the hearing of that patient with the testing device 120. The handheld device 130 may also download information associated with a patient to the MIS for backup purposes after the hearing test.

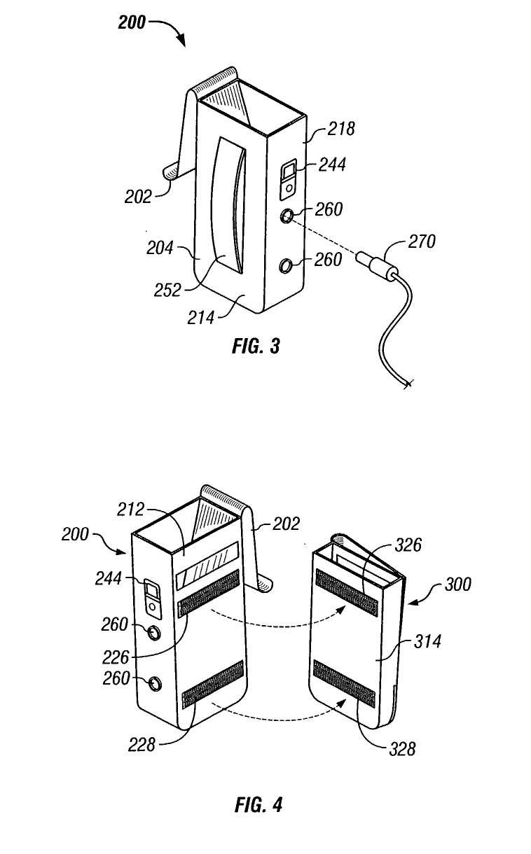

In addition to being in communication with each other via the communication link 150, the testing device 120 and the handheld device 130 may be physically fastened together to operate as the single portable auditory testing system 170. That is, the testing device 120 and the handheld device 130 may be directly fastened to each other. Alternatively, the testing device 120 may be retained in a carrying member (e.g., a carry case, a holster, a carry pouch, and a carry sleeve), and the handheld device 130 may be fastened to the carrying member. The testing device 120 and the handheld device 130 may also be retained in separate carrying members, which in turn, may be fastened together as described in detail below. Referring to FIGS. 2 and 3, a first carrying member 200 adapted to retain the testing device 120 is shown. Although the embodiments disclosed herein are particularly well suited for use with a carrying member such as a carry case, persons of ordinary skill in the art will readily appreciate that the teachings herein are in no way limited to carry cases. On the contrary, persons of ordinary skill in the art will readily appreciate that the teachings can be employed with other carrying members such as a holster, a carry pouch, and a carry sleeve to hold the testing device 120.

To illustrate the concept of retaining the testing device 120, the first carrying member 200 may include a top portion 202 and a base portion 204. A portion of the testing device 120 may be disposed within the base portion 204 while the top portion 202 may secure the testing device 120 in the base portion 204. In particular, the base portion 204 includes a front portion 212, a rear portion 214, a first side portion 216, and a second side portion 218. The front portion 212 includes a viewing area 222, which may be, but is not limited to, an aperture and a clear plastic cover. Accordingly, a built-in display of the testing device 120 may be viewed through the viewing area 222. The front portion 212 also includes a first fastener 224 to attach a second carrying member (shown as 300 in FIG. 4) to the first carrying member 200. Persons of ordinary skill in the art will readily appreciate that the second carrying member 300 may be fastened to the first carrying member 210 in many ways such as a snap-on mechanism, a slide-in mechanism, and other mechanically joining mechanisms. For example, the first fastener 224 may include a first fastening strip 226 and a second fastening strip 228 of Velcro-like material. Each of the first and second fastening strips 226, 228 may be pressed to a corresponding fastening strip of Velcro-like material disposed on a rear portion 314 of the second carrying member 300, which is adapted to retain the handheld device 130. To illustrate the concept of fastening the testing device 120 and the handheld device 130 together as a single portable auditory testing system 170, a first corresponding strip 326 and a second correspond strip 328 of Velcro-like material are disposed on the rear potion 314 of the second carrying member 300 as shown in FIG. 4. The first fastening strip 226 and the first corresponding strip 326 may be pressed together as persons of ordinary skill in the art will readily recognize. Accordingly, the second fastening strip 228 and the second corresponding strip 328 may be pressed together. The first and second carrying members 200, 300 may be fastened together, and as a result, the portable auditory testing device 120 and the mobile handheld device 130 may be fastened together as a single portable auditory testing system 170. Alternatively, the first and second corresponding strips 326, 328 may be disposed on a rear portion of the handheld device 130 such that the handheld device 130 is directly fastened to the first carrying member 200.

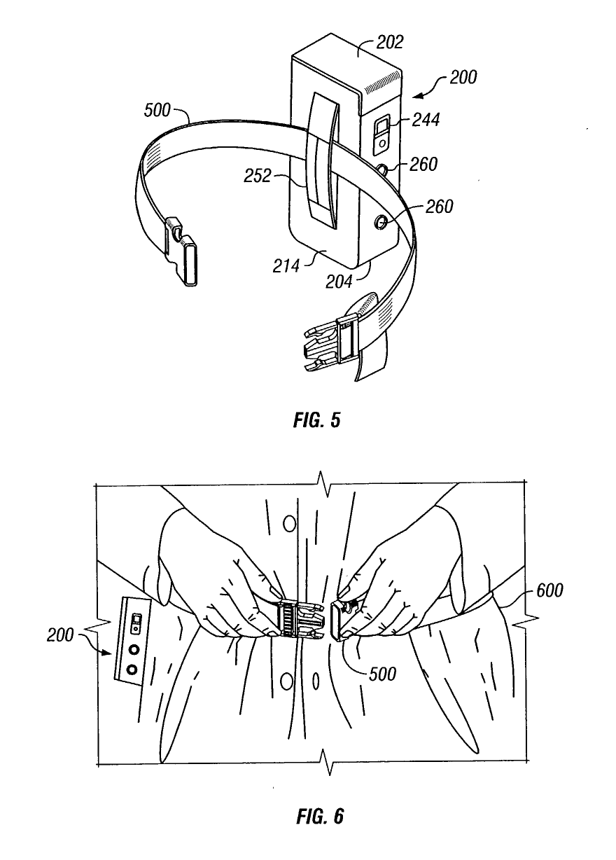

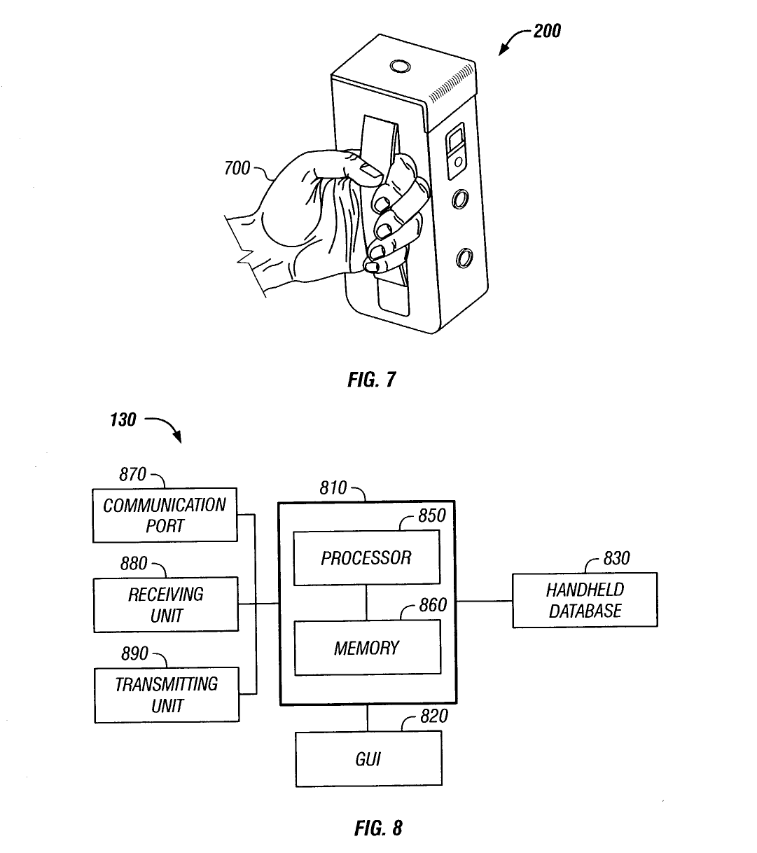

Referring back to FIGS. 2 and 3, the first carrying member 200 may also include a first strap loop 242 and a second strap loop 244. In particular, the first strap loop 242 is disposed on the first side portion 216, and the second strap loop 244 is disposed on the second side portion 218. The first and second strap loops 242, 244 may be used to engage a strap (not shown) so that a user of the testing device 120 may carry the carrying member 200 over a shoulder or the chest of the user. For example, one end of the strap may include a first hook to clasp the first strap loop 242 while the other end of the strap may include a second hook to clasp the second strap loop 244. The carrying member 200 may also include a second fastener 252 disposed on the rear portion 214. For example, the second fastener 252 may be a belt loop (shown as 500 in FIG. 5) adapted to engage a belt of the user of the testing device 120. The belt 500 may be disposed through the loop 252 so that the user may secure the carrying member 210 on the waist 600 of the user as shown in FIG. 6. Alternatively, the user may carry the testing device 120 by holding the belt loop 500 of the carrying member 210 with a hand 700 as shown in FIG. 7. Other examples of the second fastener 252 may be, but are not limited to, a belt clip, and a hook. Thus, the user may easily transport the portable auditory testing system 170 (i.e., the portable auditory testing device 120 and the mobile handheld device 130) to different locations such as bedside to bedside of different patients.

As noted above, the handheld device 130 is in communication with the testing device 120 via the first communication link 150 so that the testing device 120 and the handheld device 130 may operate as a single unit, i.e., the portable auditory testing system 170. Accordingly, the carrying member 210 may also include a plurality of communication areas 260 for access to communication ports of the testing device 120 so that the testing device 120 and the handheld device 130 may be communicatively coupled together. Referring back to FIG. 3, for example, the plurality of communication areas 260 may be, but are not limited to, apertures for a cable 270 to connect the handheld device 130 to the testing device 120 and to establish a wired link between the two devices 120, 130. Alternatively, the plurality of communication areas 260 may be clear plastic covers so that the testing device 120 and the handheld device 130 may communicate via an infrared link.

Referring to FIG. 8, a handheld device 130 adapted to enhance the capability of a testing device 120 is shown. The handheld device 130 generally includes a controller 810, a graphical user interface (GUI) 820, and a database 830. The controller 810 includes a processor 850 and a memory 860. The processor 850 is operatively coupled to the memory 860, which stores a program or a set of operating instructions for the processor 850. The processor 850 executes the program or the set of operating instructions such that the handheld device 130 operates as described herein. The program of the set of operating instructions may be embodied in a computer-readable medium such as, but not limited to, paper, a programmable gate array, an application specific integrated circuit (ASIC), an erasable programmable read only memory (EPROM), a read only memory (ROM), a random access memory (RAM), a magnetic media, and an optical media.

As noted above and shown in FIG. 1, the handheld device 130 is in communication with the testing device 120 via the first communication link 150, i.e., the testing device 120 and the handheld device 130 are communicatively coupled together. For example, the first communication link 150 may be a wired link such that the cable 270 may connect the testing device 120 and the handheld device 130 together to operate as a single unit, i.e., the portable auditory testing system 170. In particular, the cable 270 is coupled to a communication port 870 of the handheld device 130 as shown in FIG. 8. The communication port 870 may be, but is not limited to, a parallel port, a serial port, and an universal serial bus (USB) port. Alternatively, the handheld device 130 may be in communication with the testing device 120 via a wireless communication link (e.g., an infrared link or a radio link). Thus, the handheld device 130 may also include a receiving unit 880 and a transmitting unit 890 operable in accordance with a wireless communication protocol such as, but not limited to, a Bluetooth based communication protocol, an IEEE 802.11 based communication protocol, and an IRDA based communication protocol to communicate with the testing device 120 via a wireless link. Persons of ordinary skill in the art will readily appreciate that the receiving unit 880 and the transmitting unit 890 may be separate components or integrated into a single component, e.g., a transceiver unit.

Using the first communication link 150, the handheld device 130 may program the testing device 120 with a hearing test protocol such as, but not limited to, a Distortion Product Otoacoustic Emissions (DPOAE) protocol and a Transiently Evoked Otoacoustic Emissions (TEOAE) protocol. That is, the handheld device 130 (e.g., via the controller 810) may download the hearing test protocol to the testing device 120 via the first communication link 140, and the testing device 120 may operate in accordance with the hearing test protocol to test the hearing of a subject.

The GUI 820 may be, for example, a color liquid-crystal (LCD) display operable to provide the user of the testing device 120 with, but not limited to, windows, pull-down menus, buttons, scroll bars, and iconic images to operate the testing device 120. In particular, the GUI 820 may be used to view distortion product (DP) grams that show signal-to-noise ratios, noise levels, noise statistics, and stimulus output associated with a hearing test of a subject. Further, the GUI 820 may also be a touch-sensitive screen for user input. That is, the GUI 820 may provide an on-screen alphanumeric keyboard to receive input from a user. Alternatively, the GUI 820 may be used in conjunction with an alphanumeric input system such as Graffiti® to receive user input.

The handheld device 130 may provide the testing device 120 with storage for information associated with patients. That is, the database 830 may store information such as hearing test data from test results of patients. Based on the hearing test data, for example, the user may view DP grams on the GUI 820 as described above.

Further, the handheld device 130 may be in communication with the network element 140 via the second communication link 160 as shown in FIG. 1 to perform other hearing testing functions. Similar to the first communication link 150, the second communication link 160 may be a wired link or a wireless link as described above. For example, the handheld device 130 may be in communication with a label printer via a wireless link (i.e., via the transmitting unit 890) to print out hearing test data associated with a subject on a self-adhesive label for the medical record of the subject. In another example, the handheld device 130 may be connected to a management information system via a cable to download information associated with a group of patients prior to performing hearing tests on the group.

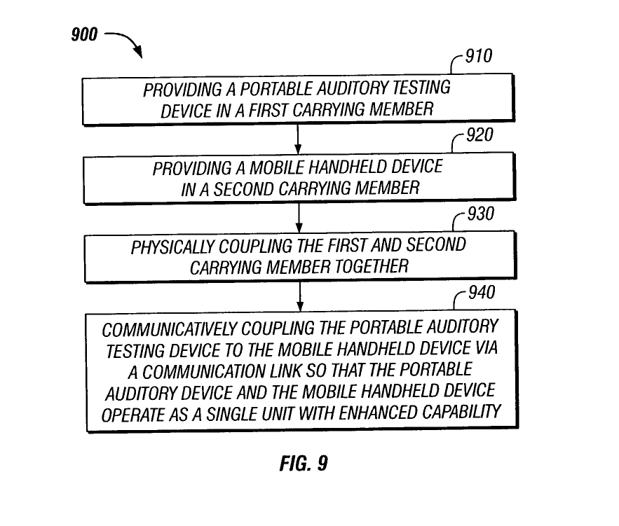

A basic flow for retrofitting a portable auditory testing device that may be applied with a mobile handheld device is shown in FIG. 9. Although a particular order of steps is illustrated in FIG. 9, persons of ordinary skill in the art will appreciate that these steps can be performed in other temporal sequences. Thus, the flow chart 900 is merely provided as an example of one way to retrofit the portable auditory testing device with the mobile handheld device to enhance the capability of the portable auditory testing device. The flow chart 900 begins at step 910, wherein the portable auditory testing device may be disposed in a first carrying member such as a carry case. At step 920, the mobile handheld device is disposed in a second carrying member, which may also be a carry case. The first carrying member at step 930 may be fastened to the second carrying member via a fastener, which may be, but is not limited to, a plurality of Velcro-like material strips. That is, the first and second carrying members may be physically coupled together. For example, each of the first and second carrying members may include a front portion and a rear portion. A first strip of Velcro-like material may be disposed on the front portion of the first carrying member, and a second strip of Velcro-like material (i.e., a corresponding strip) may be disposed on the rear portion of the second carrying member. The first and second strips of Velcro-like material may be pressed together to fasten the first and second carrying members to each other. Accordingly, the portable auditory testing device and the mobile handheld device may be fastened together. At step 940, a communication link between the portable auditory testing device and the mobile handheld device may be provided so that the mobile handheld device is in communication with the portable auditory testing device. That is, the portable auditory testing device and the mobile handheld device are communicatively coupled together. For example, a cable may connect the mobile handheld device to the portable auditory testing device so that the portable auditory testing device and the mobile handheld device may operate as a single unit with enhanced capability. In particular, the mobile handheld device may provide the portable auditory testing device with a database to store information associated with a subject such as hearing test results. The mobile handheld device may also provide a graphical user interface (GUI) to view DP gram of a hearing testing result. Thus, the portable auditory testing device and the mobile handheld device may operate as a portable auditory testing system to perform hearing tests.

Many changes and modifications to the embodiments described herein could be made. The scope of some changes is discussed above. The scope of others will become apparent from the appended claims.

What is claimed is:

1. In an auditory testing environment, wherein a portable testing device is operable to test the hearing of a subject, a method for enhancing the capability of the portable testing device, the method comprising:
providing a portable handheld device, the portable handheld device comprising:
a graphical user interface;
a database operable to store information associated with at least one subject; and
a controller operatively coupled to the graphical user interface and the database;
the controller being programmed to control the first portable device via the
communication link; and
communicatively coupling the portable testing device to the portable handheld device via a communication link so that the portable testing device and the portable handheld device operate as a single portable auditory testing unit.

2. The method of claim 1, wherein the step of communicatively coupling the portable testing device to the portable handheld device via a communication link so that the portable testing device and the portable handheld device operate as a single portable auditory testing unit comprises communicatively coupling the portable testing device to the portable handheld device via a wired link so that the portable testing device and the portable handheld device operate as a single portable auditory testing unit, wherein the wired link is a cable.

3. The method of claim 1, wherein the step of communicatively coupling the portable testing device to the portable handheld device via a communication link so that the portable testing device and the portable handheld device operate as a single portable auditory testing unit comprises communicatively coupling the portable testing device to the portable handheld device via a wireless link so that the portable testing device and the portable handheld device operate as a single portable auditory testing unit, wherein the portable testing device and the portable handheld device operate in accordance with a wireless communication protocol.

4. The method of claim 1, wherein the graphical user interface comprises one of a color liquid-crystal display (LCD) and a touch-sensitive screen.

5. The method of claim 1, wherein the database comprises a database operable to store hearing test data associated with at least one subject.

6. The method of claim 1 further comprising the step of communicatively coupling the portable testing device and the portable handheld device to a network element via a communication link, wherein the network element is one of a printer, a monitor, a laptop computer, a desktop computer, a management information system, and a personal digital assistant (PDA).

7. The method of claim 1 further comprising the step of communicatively coupling the portable testing device and the portable handheld device to a network element via a wireless link, wherein the wireless link operates in accordance with one of a Bluetooth based communication protocol and an Institute of Electrical and Electronics Engineers (IEEE) 802.11 based communication protocol.

8. In an auditory testing environment, wherein a portable auditory testing device is operable to test the hearing of a subject, a method for retrofitting the portable auditory testing device, the method comprising:
providing the portable auditory testing device within a first carrying member;
providing a mobile handheld device within a second carrying member;
physically coupling the first carrying member and the second carrying member together;
communicatively coupling the portable auditory testing device to the mobile handheld device via a first communication link so that the mobile handheld device is operable to control the portable auditory testing device for a hearing test;
communicatively coupling the portable auditory testing device and the mobile handheld device to a network element via a second communication link;
providing a user-input device within the mobile handheld device;
providing a graphical user interface within the mobile handheld device to view information associated with at least one subject; and
providing a database within the mobile handheld device to store information associated with at least one subject.

9. The method of claim 8, wherein the step of providing the portable auditory testing device within a first carrying member comprises providing the portable auditory testing device within one of a carry case, a holster, a carry sleeve, and a carry pouch.

10. The method of claim 8, wherein the step of physically coupling the first carrying member and the second carrying member together comprises physically coupling the first carrying member and the second carrying member together via a plurality of Velcro-like material strips, wherein at least one of the plurality of Velcro-like material strips is disposed on each of the first and second carrying members.

11. The method of claim 8, wherein the step of communicatively coupling the portable auditory testing device to the mobile handheld device via a first communication link so that the mobile handheld device is operable to control the portable auditory testing device for a hearing test comprises communicatively coupling the portable auditory testing device to the mobile handheld device via one of a wired link and a wireless link so that the mobile handheld device is operable to control the portable auditory device for a hearing test.

12. The method of claim 8, wherein the step of communicatively coupling the portable auditory testing device and the mobile handheld device to a network element via a second communication link comprises communicatively coupling the portable auditory testing device and the mobile handheld device to one of a printer, a monitor, a laptop computer, a desktop computer, a management information system, and a personal digital assistant (PDA) via a second communication link.

13. The method of claim 8, wherein the step of communicatively coupling the portable auditory testing device and the mobile handheld device to a network element via a second communication link comprises communicatively coupling the portable auditory testing device and the mobile handheld device to a network element via one of a wired link and a wireless link.

14. The method of claim 8, wherein the step of providing a user-input device within the mobile handheld device comprises providing an alphanumeric keypad within the mobile handheld device.

15. The method of claim 8, wherein the step of providing a graphical user interface within the mobile handheld device comprises providing one of a color liquid-crystal display (LCD) and a touch-sensitive screen within the mobile handheld device.

16. The method of claim 8, wherein the step providing a database within the mobile handheld device to store information associated with at least one subject comprises providing a database within the mobile handheld device to store hearing test data associated with at least one subject.

17. The method of claim 8, wherein the mobile handheld device comprises a personal digital assistant (PDA).

18. A portable auditory testing system comprising:
a carrying member;
a portable auditory testing device disposed in the carrying member, the portable auditory testing device being operable to test the hearing of a subject; and
a mobile handheld device physically coupled to the carrying member via a fastener, the mobile handheld device being in communication with the portable auditory testing device via a communication link, and the mobile handheld device comprising:
a graphical user interface;
a database adapted to store information associated with at least one subject; and
a controller operatively coupled to the graphical user interface and the user input interface, the controller comprising a processor and a memory operatively coupled to the processor,
the controller being programmed to operate the portable auditory testing device via the communication link.

19. The system of claim 18, wherein the carrying member is one of a carry case, a holster, a carry sleeve, and a carry pouch.

20. The system of claim 18, wherein the carrying member comprises a first strap loop and a second strap loop, the first and second strap loops being operable to couple a strap.

21. The system of claim 18, wherein the mobile handheld device is one of a personal digital assistant (PDA) and a cellular telephone.

22. The system of claim 18, wherein the communication link is one of a wired link and a wireless link.

23. The system of claim 18, wherein the mobile handheld device operates in accordance with one of a Bluetooth based communication protocol and an Institute of Electrical and Electronics Engineers (IEEE) 802.11 based communication protocol.

24. The system of claim 18, wherein the graphical user interface is one of a color liquid crystal display (LCD) and a touch-sensitive screen.

25. The system of claim 18, wherein the database is a database adapted to store hearing test data associated with at least one subject.

26. The system of claim 18, wherein the fastener is a plurality of Velcro-like material strips, wherein at least one of the plurality of Velcro-like material strips is disposed on each of the carrying member and the mobile handheld device.

27. The system of claim 18, wherein the communication link is a first communication link, and wherein the mobile handheld device is communication with a network element via a second communication link, the network element being one of a printer, a monitor, a laptop computer, a desktop computer, a management information system, and a personal digital assistant (PDA).

28. The system of claim 18, wherein the fastener is a first fastener, and wherein the carrying member comprises a second fastener, the second fastener being one of a belt loop, a belt clip, and a hook.

29. A system for testing the hearing of a patient, the system comprising:
a first carrying member having a front portion;
a second carrying member having a rear portion, the second carrying member being physically coupled to the first carrying member via a plurality of Velcro-like material strips, at least one of the plurality of Velcro-like material strips is disposed on each of the front portion of the first carrying member and the rear portion of the second carrying member;
a portable auditory testing device disposed within the first carrying member, the portable auditory testing device being operable to test the hearing of a patient; and
a mobile handheld device disposed within the second carrying member, the mobile handheld device being in communication with the portable auditory testing device via a cable, and the mobile handheld device comprising:
a liquid crystal display;
a user input device;
a database adapted to store hearing test data associated with at least one patient; and
a controller operatively coupled to the liquid crystal display, the user input device, and the database, the controller comprising a processor and a memory operatively coupled to the processor,
the controller being programmed to operate the portable auditory testing device via the cable between the portable auditory testing device and the mobile handheld device.
